(19) United States
(12) Patent Application Publication
(10) Pub. No.: US 2013/0145257 A1
(43) Pub. Date: Jun. 6, 2013

(54) Edition Designer

(71) Applicants: Sami Mohammed SHALABI, Winchester, MA (US); Maurice Bennett SHORE, Carlisle, MA (US); Cassandra Lynn DOLL, Santa Clara, CA (US)

(72) Inventors: Sami Mohammed SHALABI, Winchester, MA (US); Maurice Bennett SHORE, Carlisle, MA (US); Cassandra Lynn DOLL, Santa Clara, CA (US)

(73) Assignee: Google Inc., Mountain View, CA (US)

(21) Appl. No.: 13/312,499

(22) Filed: Dec. 6, 2011

(51) Int. Cl. G06F 17/00

(52) U.S. Cl. 715/243

(57) ABSTRACT

A system, computer-implemented method and computer-readable medium for designing different magazine editions are provided. A studio backend provides a user interface for designing magazine editions and enabling a user to select content sources to provide the edition content in magazine editions. The studio backend, through the user interface, further enables the user to select layout templates for different magazine editions. Each layout template being associated with a specific type of a mobile device. The selected layout templates may be configured to define the display of edition content in magazine editions. The studio backend then sends the configured layout templates for the magazine editions to the plurality of mobile devices, where magazine editions may be displayed on mobile devices according to the configured layout templates and include the edition content for the magazine editions.

### BACKGROUND

Users gain access to media content via the Internet or the World Wide Web (or simply the “Web”) using websites. In one example, users enter a website address on their mobile device to access media content. In another example, users may download an application provided by a particular content provider onto their mobile device. The application then presents a user with a media content that is periodically uploaded to the application from a content source provided by the content provider. However, the design, presentation and publication of a media content application can be time consuming and arduous.

Moreover, because computing devices have unique specifications that include different operating platforms, a content provider needs to tailor each application to fit the processing requirements of a particular mobile device. As a result, a content provider needs to develop and maintain multiple applications that perform the same function, so that their content can reach as many users as possible.

### BRIEF SUMMARY

Embodiments including a system, computer-implemented method and computer-readable medium for designing different magazine editions are provided. A studio backend is configured to provide a user interface for designing the magazine editions and enable a user to select through the user-interface at least one content source to provide respective edition content in respective magazine editions. The studio backend, through the user interface further enables the user to select one or more layout templates for different magazine editions through the user interface, each layout template being associated with a specific type of each mobile device and configure the selected layout templates to define the display of respective edition content in respective magazine editions. The studio backend then sends the configured layout templates for the respective magazine editions to the plurality of mobile devices, where magazine editions may be displayed at the plurality of mobile devices according to the respective configured layout templates and includes the edition content for the respective magazine editions.

Further embodiments, features, and advantages of the invention, as well as the structure and operation of the various embodiments of the invention are described in detail below with reference to the accompanying drawings.

### BRIEF DESCRIPTION OF THE DRAWINGS/FIGURES

The accompanying drawings, which are incorporated herein and form a part of the specification, illustrate embodiments of the invention and, together with the description, further serve to explain the principles of the invention and to enable a person skilled in the relevant art to make and use the invention.

FIG. 1A is a block diagram of a distributed system environment, according to an embodiment.

FIG. 1B is a block diagram of components that generate and distribute magazine editions, according to an embodiment.

FIG. 1C is a block diagram that describes an exemplary communication interfaces between the components within the distributed system, according to an embodiment.

FIG. 2A is a block diagram of an edition player, according to an embodiment.

FIGS. 2B-2Q are screenshots of various configurations for designing a magazine edition in studio UI, according to an embodiment.

FIG. 3 is a block diagram of an applications data model, according to an embodiment.

FIG. 4 is a flowchart of a method for designing a magazine edition, according to an embodiment.

FIG. 5 is an example computer system in which embodiments of the present invention, or portions thereof, may be implemented as computer-readable code.

Certain embodiments of the invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF EMBODIMENTS

The following detailed description refers to the accompanying drawings that illustrate certain embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

### System Overview

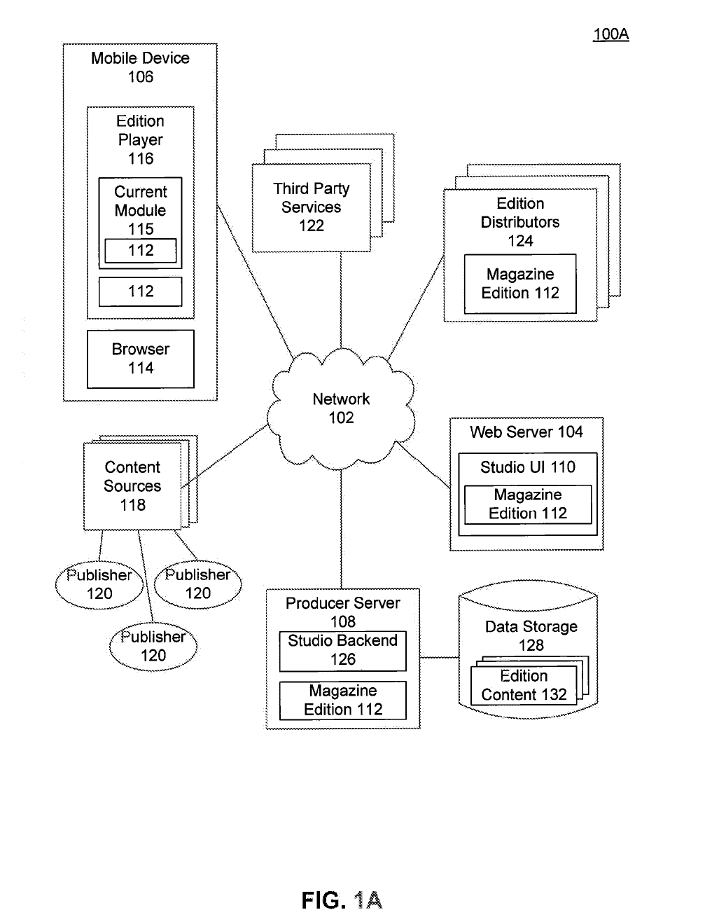

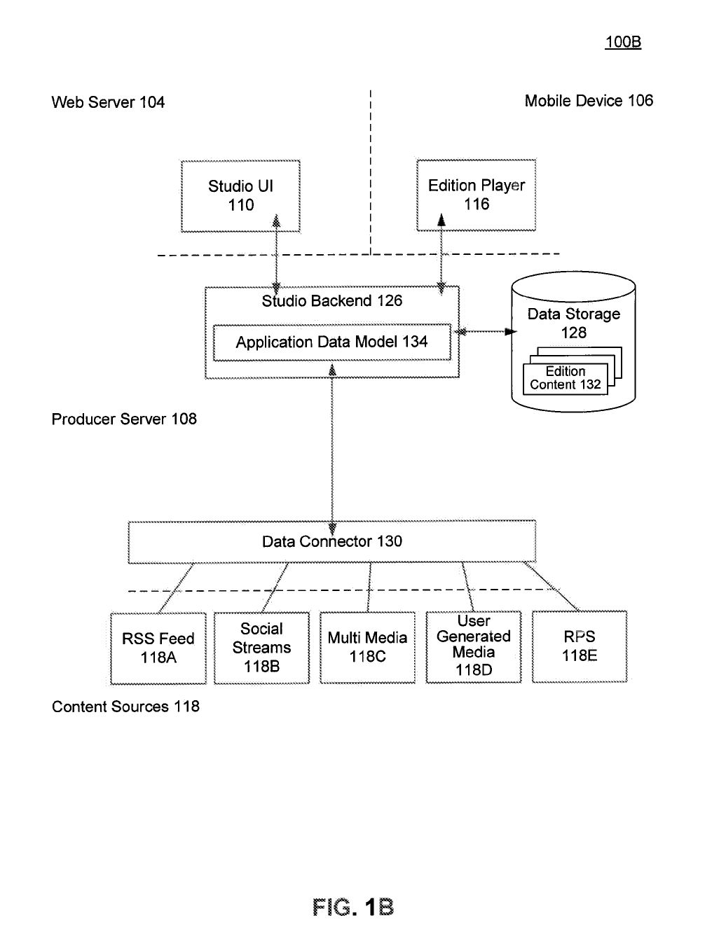

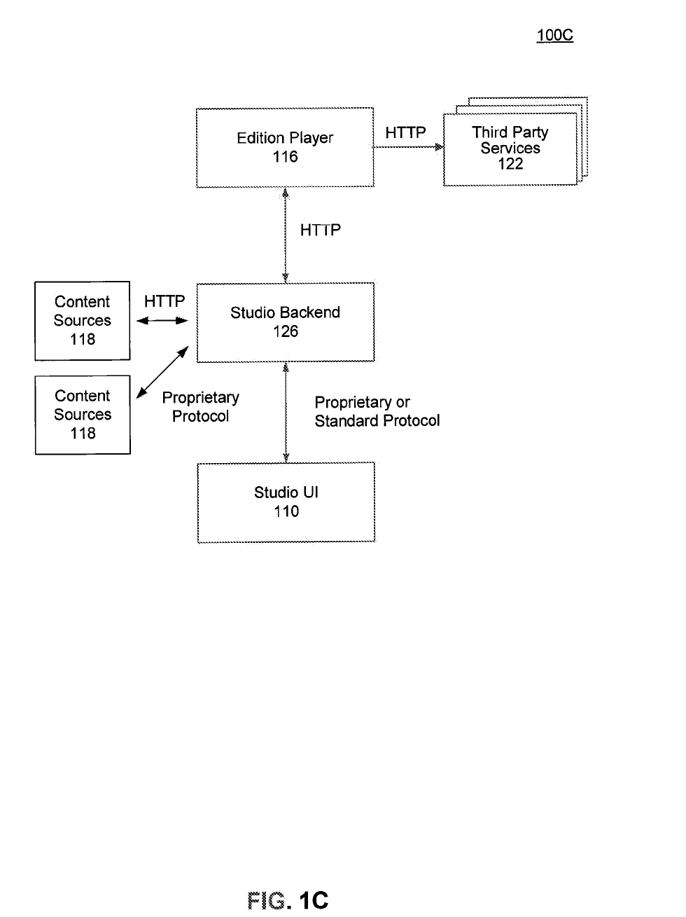

FIG. 1A is a block diagram 100A of a distributed system environment. Distributed system environment 100A includes one or more networks 102, web servers 104, producer servers 108 and mobile devices 106.

Network 102 may be any network or combination of networks that can carry data communications. Such a network 102 may include, but is not limited to, a local area network, metropolitan area network, and/or wide area network such as the Internet. Network 102 can support protocols and technology including, but not limited to, the World Wide Web (or simply the “Web”), protocols such as a Hypertext Transfer Protocol (“HTTP”) protocols, and/or services. Intermediate web servers, gateways, or other servers may be provided between components of the system shown in FIG. 1, depending upon a particular application or environment.

Web server 104 is a computing device or an application executing on a computing device that hosts multiple websites. A website is one or more resources associated with a domain name and hosted by one or more web servers 104. An example website is a collection of webpages formatted in hypertext markup language (HTML) that can contain text, images, multimedia content, and programming elements, such as scripts. Web server 104 hosts studio user interface (“UI”) 110. Studio UI 110 enables users, such as publishers 120, to design interactive magazine editions 112 that may be distributed to multiple mobile devices 106. Publisher 120 may access studio UI 110 using a web address that is hosted on web server 104. Once accessed, publisher 120 may use studio UI 110 to design the layout of magazine edition 112 and configure content sources 118 for mobile devices 106 having different specifications.

In another embodiment, publisher 120 may download studio UI 110 onto a mobile device 106 as a standalone application or as a plugin or extension to a browser.

Magazine editions 112 are designed using studio UI 110. Magazine edition 112 displays edition content to users in, for example, a format specified by publishers 120. However, unlike conventional applications that include a separate version for each mobile device having a particular operating platform, edition content displayed using magazine editions 112 may be displayed on mobile devices 106 in a format that is specified by a particular publisher, regardless of the native operating platform particular to mobile device 106. Magazine editions 112 may also lay out edition content according to the specifications of mobile device 106, such as a size of a display screen.

Mobile device 106 is an electronic device that is under the control of a user and is capable of requesting and receiving resources over network 102. Example mobile devices 106 are mobile communication devices such as smart phones and tablet computers. Mobile device 106 typically includes an application, such as a web browser (or simply browser) 114. A user controls browser 114 to request resources over network 102. A user requests a resource by typing the website address associated with the resources that is stored on web server 104. For example, a user, such as publisher 120 may use browser 114 to access studio UI 110 to design an interactive magazine edition using mobile device 106.

Mobile device 106 also includes edition player 116. Edition player 116 displays magazine editions 112 to users. Edition player 116 may be a standalone application on mobile device 106, or a plugin or extension to browser 114. Magazine edition 112 displays dynamic media content on mobile devices 106, where mobile devices have different specifications and display screen size. Edition content included in magazine editions 112 includes content downloaded to magazine editions 112 using content sources 118. To display magazine editions 112, edition player 116 may use a current module 115 or display edition content using edition player 116.

Current module 115 stores magazine editions 112 which are published by publisher 120. Current module 115 may be downloaded to mobile device 106 from, for example, producer server 108 using network 102 or using another interface. Typically, once current module 115 is downloaded to mobile device 106, a user uses current module 115 to subscribe to magazine editions 112. Once subscribed, current module 115 uses mobile device 106 to download magazine editions 112 from producer server 108, or edition distributor 124. Current module 115 also updates magazine edition 112 with new edition content. In an embodiment, current module 115 also provides a user with a listing of recommended magazine editions 112 that may be of interest to the user and that a user may subscribe to.

Producer server 108 includes studio backend 126. Studio backend 126 allows for a design, development and implementation of magazine editions 112. Studio backend 126 communicates with studio UI 110 when publisher 120 uses studio UI 110 to design magazine edition 112.

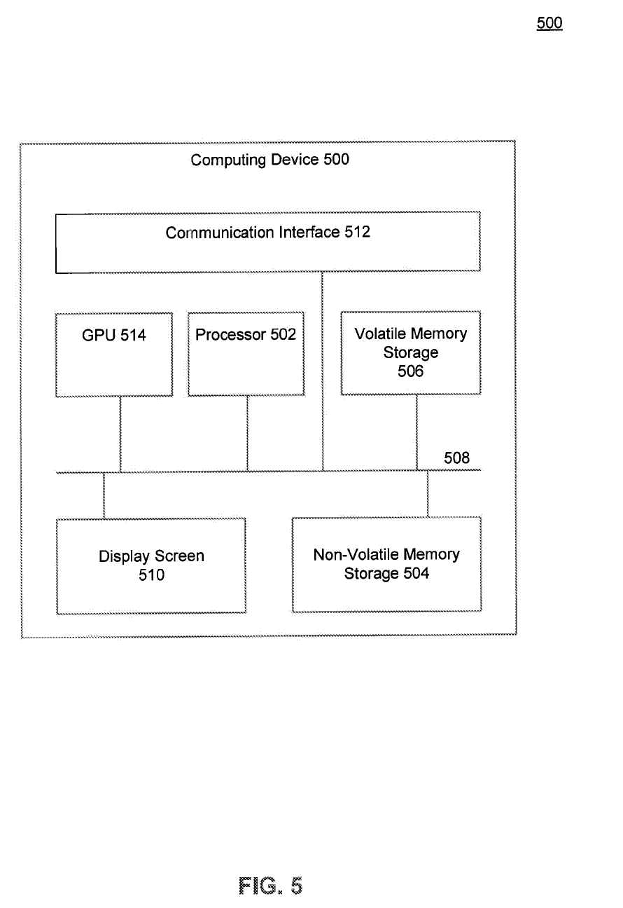

Once publisher 120 completes designing magazine edition 112 using studio UI 110, magazine edition 112 is uploaded to producer server 108 for storage and distribution. In an embodiment, magazine editions 112 may be stored on producer server 108 in a memory storage described in detail in FIG. 5. In another embodiment, publisher 120 may upload magazine edition 112 to edition distributors 124. A user may access edition distributor 124 and download magazine edition 112 to mobile device 106. In an embodiment, once publisher 120 decides to distribute an upgraded magazine edition 112, mobile devices 106 that include a previous version of magazine edition 112 are synchronized with the upgraded magazine edition 112.

Content sources 118 provide edition content 132 to magazine edition 112. Example content sources 118 include data feeds, RSS feeds, social streams, user-generated media sources, multi-media sources via media RSS, etc. Content source 118 is typically associated with publisher 120. Publisher 120 owns a particular content source 118 and controls edition content 132 that is distributed via content sources 118 over network 102.

Producer server 108 receives edition content 132 from content sources 118. Once received, producer server 108 stores edition content 132 in data storage 128. Data storage 128 may be a memory storage described in detail in FIG. 5. In an embodiment, data storage 128 may include a database for storing edition content 132. When magazine edition 112 executing on edition player 116 requests edition content 132, producer server 108 retrieves edition content 132 from data storage 128 and transmits edition content 132 to edition player 116.

Third party services 122 provide services to magazine editions 112. For example, third party services 122 provide streaming video that may be accessed by a uniform resource locator (“URL”) link included in magazine edition 112. In another example, third party services 122 determine that a user read a particular article included in magazine edition 112. In another example, third party services 122 provide advertisements for display within magazine edition 112. In another example, third party services 122 provide check out services for merchandise items that are provided for purchase within magazine edition 112.

Edition distributors 124 distribute applications, such as magazine editions 112 to mobile devices 106. For example, when publisher 120 designs magazine edition 112, publisher 120 may elect a particular edition distributor 124 to distribute magazine edition 112. When publisher 120 elects to distribute magazine edition 112 using a particular edition distributor 124, magazine edition 112 is uploaded to edition distributor 124. A user may then use mobile device 106 to access edition distributor 124 and upload magazine edition 112 onto mobile device 106 for an agreed upon fee.

FIG. 1B is a block diagram 100B of components in distributed system 100 that generate and distribute magazine editions.

As described herein content sources 118 provide edition content 132 that is distributed across the web via network 102. For edition content 132 to be distributed using magazine editions 112, content sources 118 are connected to producer server 108. In an embodiment, data connector 130 connects multiple content sources 118 and retrieves edition content 132.

Data connector 130 receives data from content sources 118. Data connector 130 may receive edition content 132 from content sources 118 in real-time or at configurable intervals that may be set by a system administrator. Once data connector 130 receives edition content 132 from content sources 118, data connector 130 may parse and transmit edition content 132 to data storage 128.

As described herein, data storage 128 distributes data from content sources 118 to magazine editions 112. For example, mobile device 106 may request data for particular magazine editions 112 at configurable time intervals that may be configured by a user subscribing to magazine editions 112.

Studio backend 126 receives the designed magazine editions 112 from studio UI 110. As described herein, studio UI 110 allows publishers 120 to design dynamic and interactive magazine editions 112 that display edition content 132 provided by their content sources 118. Once publisher 120 completes designing magazine edition 112, publisher 120 uploads magazine edition 112 to studio backend 126. Studio backend 126 then stores the uploaded magazine editions 112 on producer server 108 and/or distributes magazine editions 112 to mobile devices 106 or edition distributors 124.

Studio backend 126 includes application data model 134. Application data model 134 includes a format that displays edition content 132 within magazine editions 112. When publisher 120 uses studio UI 110 to create a particular magazine edition 112, studio UI 110 presents publisher 120 with application data model 134 framework that publisher 120 may configure to include edition content 120 for presentation to a user.

Upon a user request from mobile device 106, studio backend 126 may distribute magazine editions 112 to mobile devices 106. Each magazine edition 112 includes application data model 134 that is configured by publisher 120.

When magazine edition 112 is uploaded to mobile device 106, magazine edition 112 is populated with edition content 132. Specifically, the application data model 134 (described below) is populated with edition content 132 as configured by publisher 120 using studio UI 110. For example, producer server 108 provides edition content 132 from data storage 128 to magazine edition 112. As edition content 132 is updated with new edition content 132 from content sources 118, producer server 108 synchronizes edition content 132 included in magazine edition 112 with the new edition content 132 that is included in data storage 128.

In an embodiment, the synchronization may occur at configurable time intervals that may be configured by a user using mobile device 106. For example, a user may configure magazine edition 112 to query data storage 128 for new content every hour, every twelve hours, once a day, when requested by a user, etc. In a further embodiment, magazine edition 112 receives edition content 132 from data storage 128 that has been updated since the previous synchronization period, as to minimize the transmission of data over network 102.

FIG. 1C is a block diagram 100C that describes an exemplary communication interface between the components within the distributed system.

For example, edition player 116 may communicate with studio backend 126 using HTTP over network 102. Edition player 116 may also communicate to third party services 122 and edition distributors 124 using HTTP.

Studio UI 110 may communicate with studio backend 126 using a Google Web Toolkit (“GWT”) infrastructure. A person skilled in the art will appreciate that GWT allows web application developers to design JavaScript front-end applications using Java source code. In an embodiment GWT uses protocol buffers, also known to a person of ordinary skill in that art, to pass data that includes magazine editions 112, templates, edition content 132, etc., between studio UI 110 and studio backend 126.

Studio backend 126 also communicates with a variety of content sources 118. In one embodiment, studio backend 126 may be configured to communicate with content sources 118 using a proprietary communication protocol that is specified by a particular content source 118. In another embodiment, studio backend 126 may also communicate with content sources 118 using HTTP.

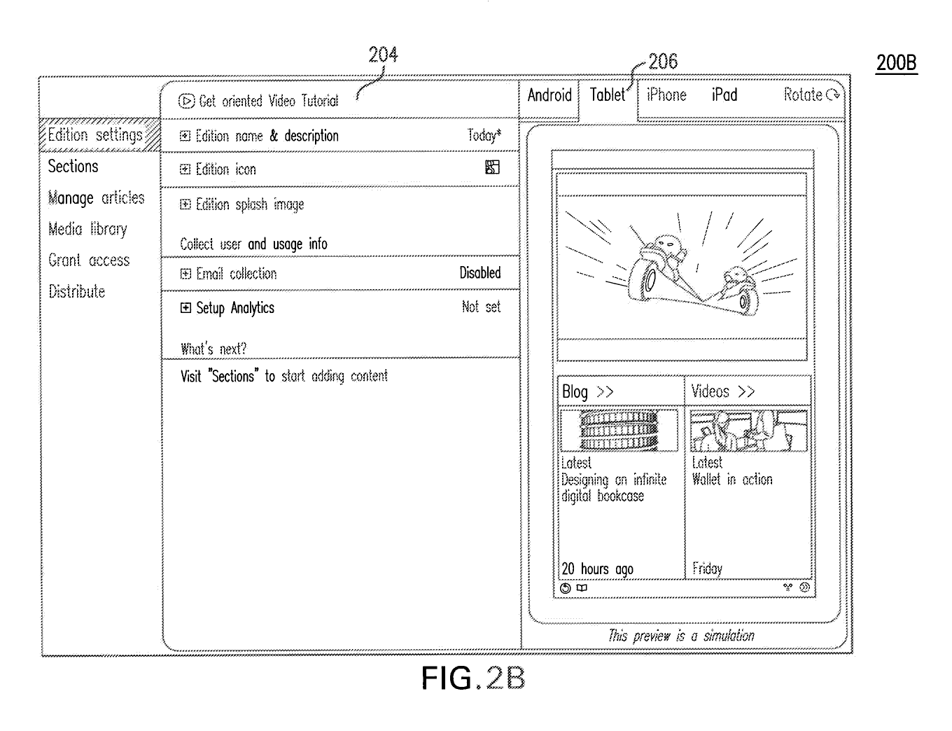

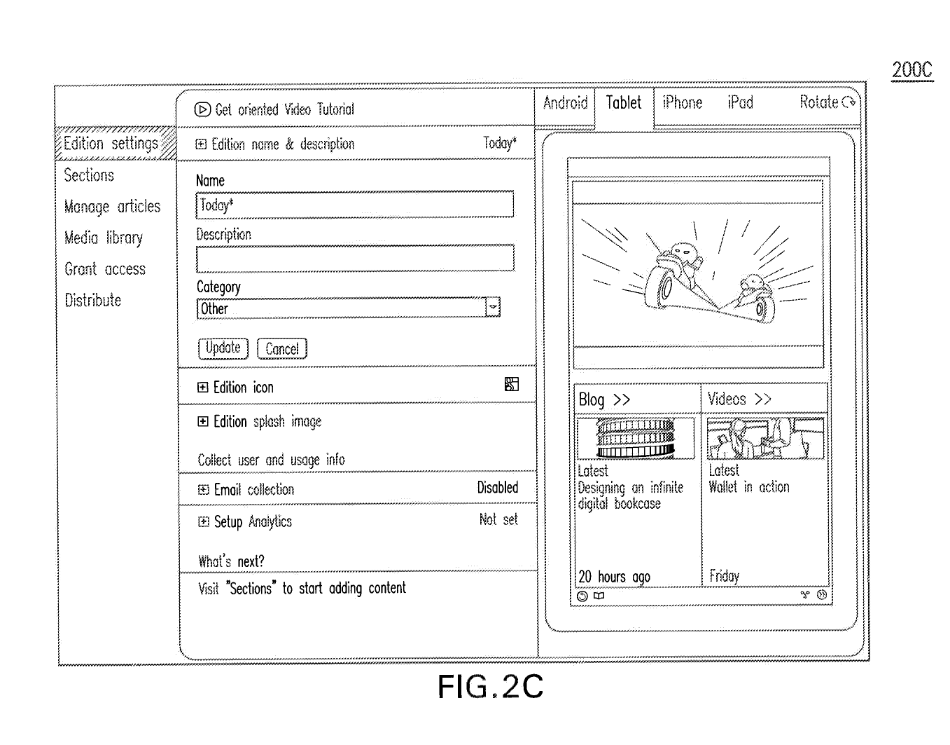

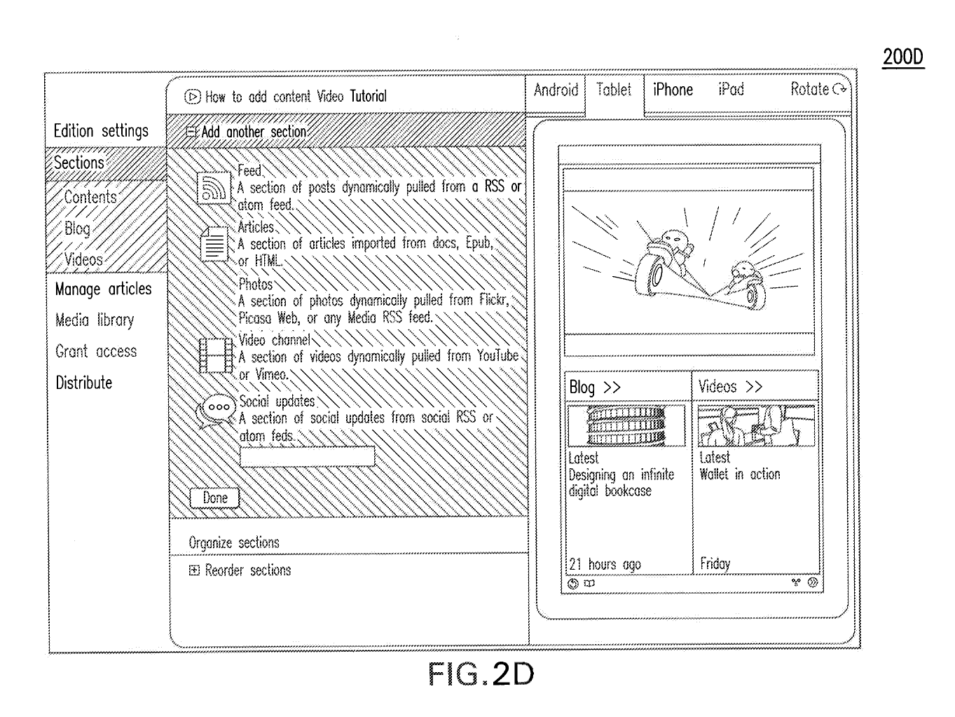

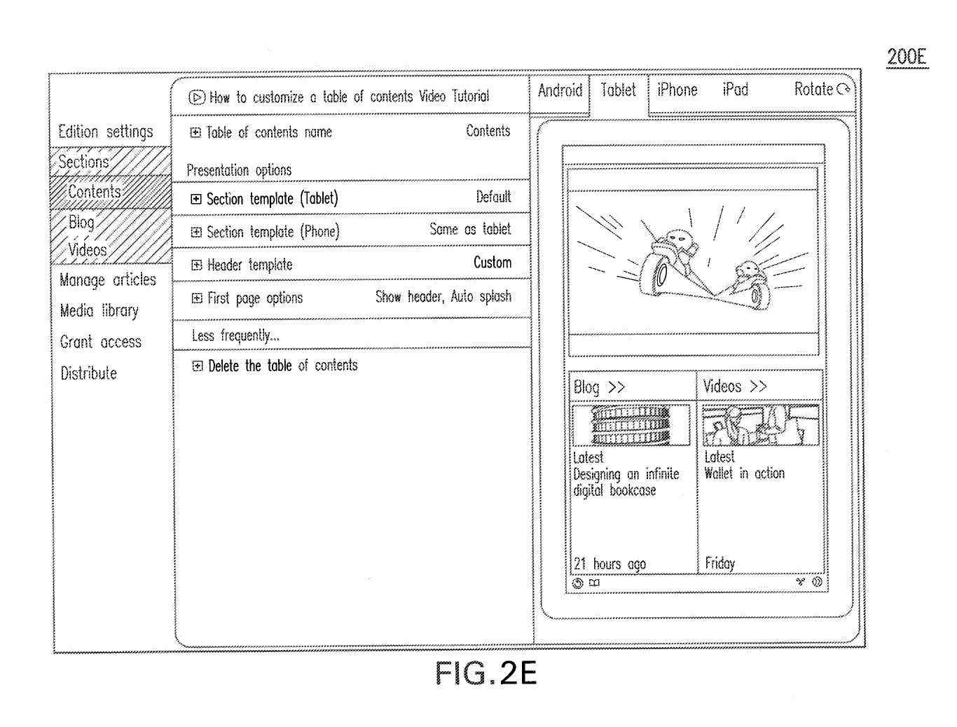

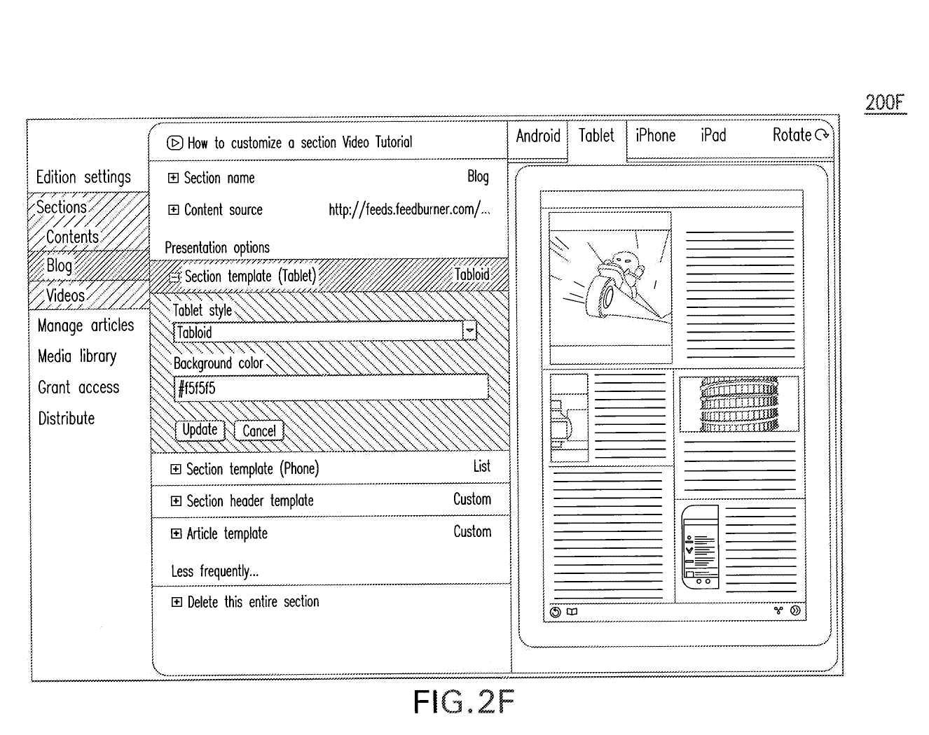

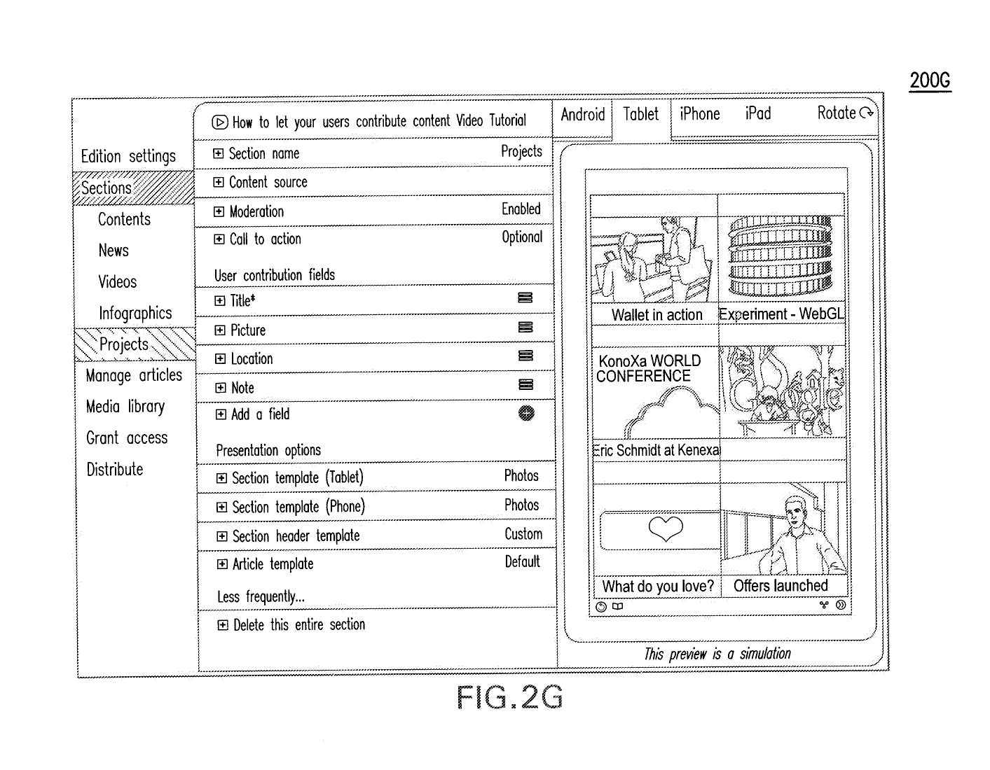

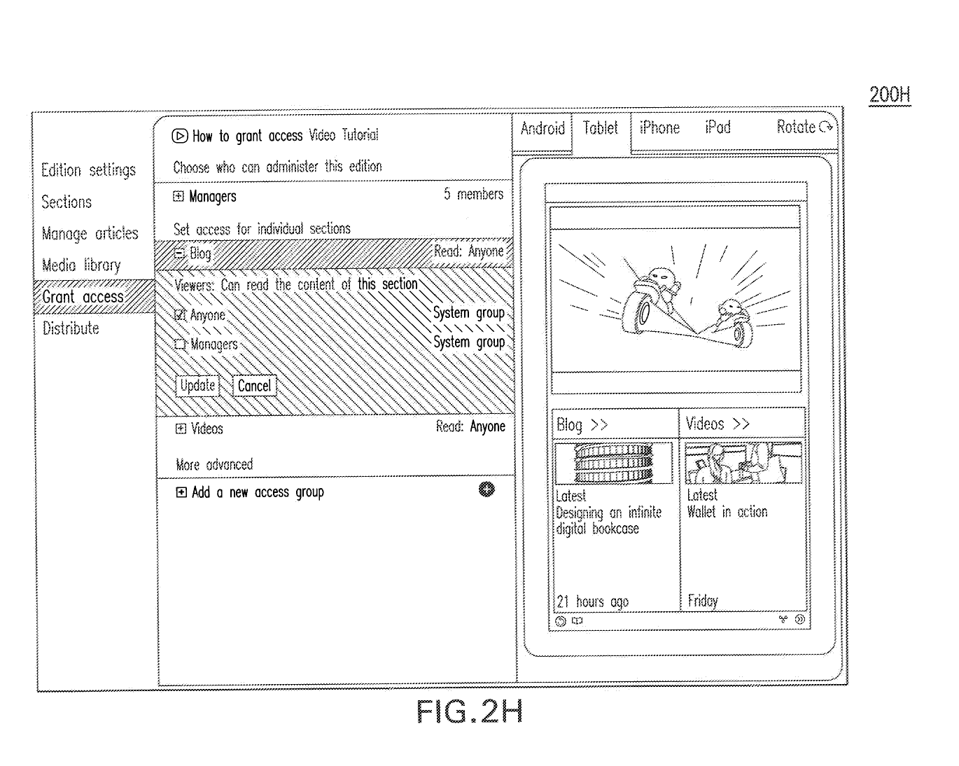

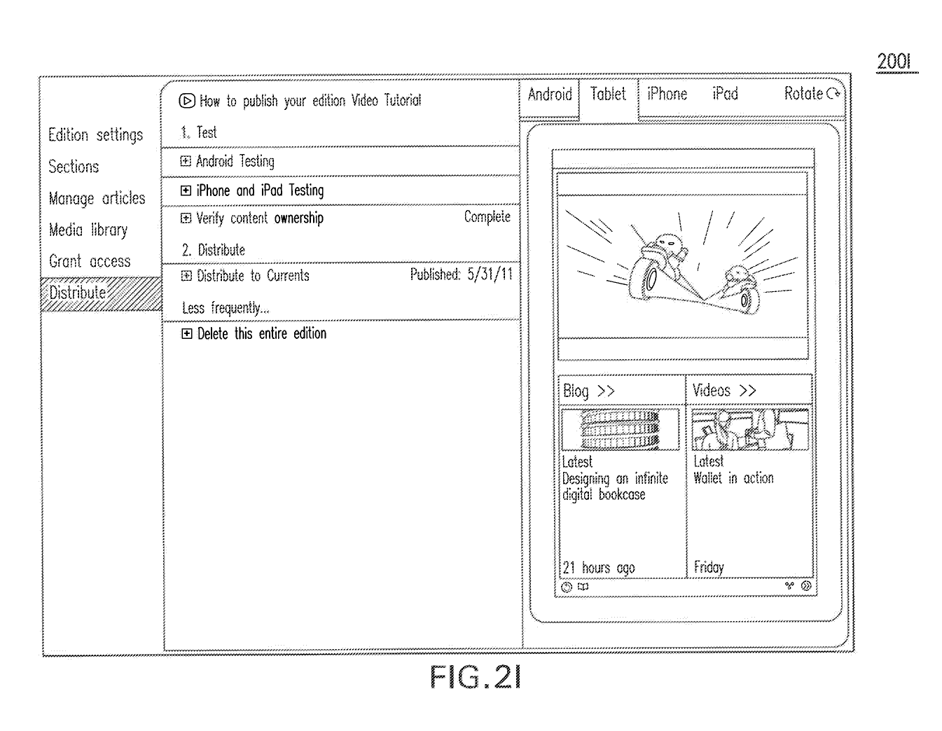

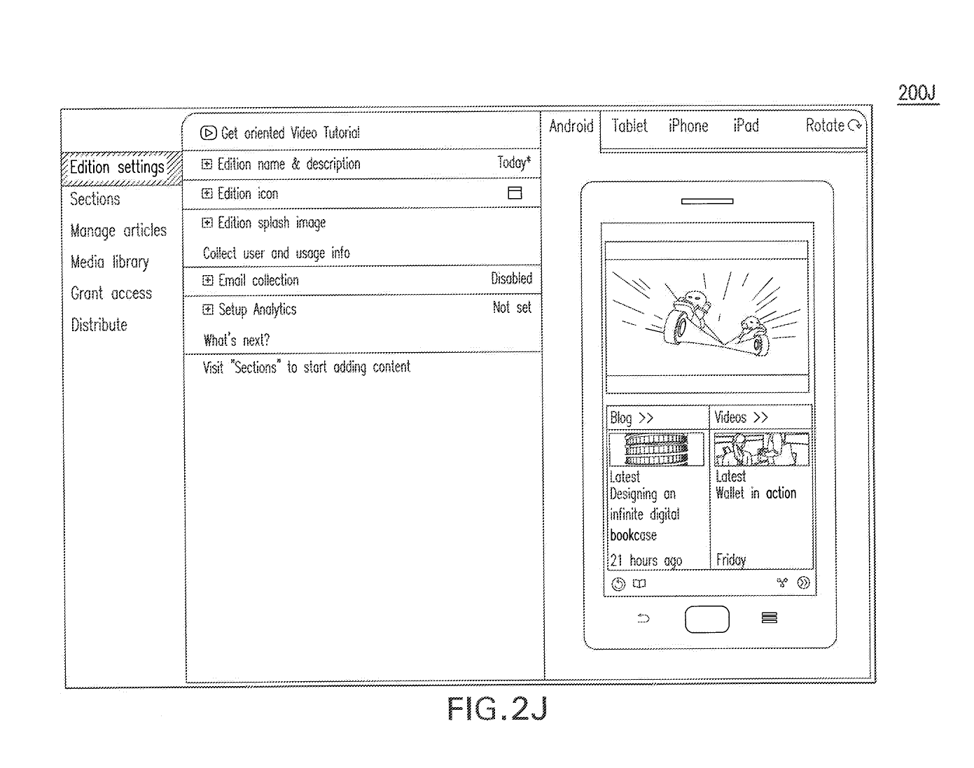

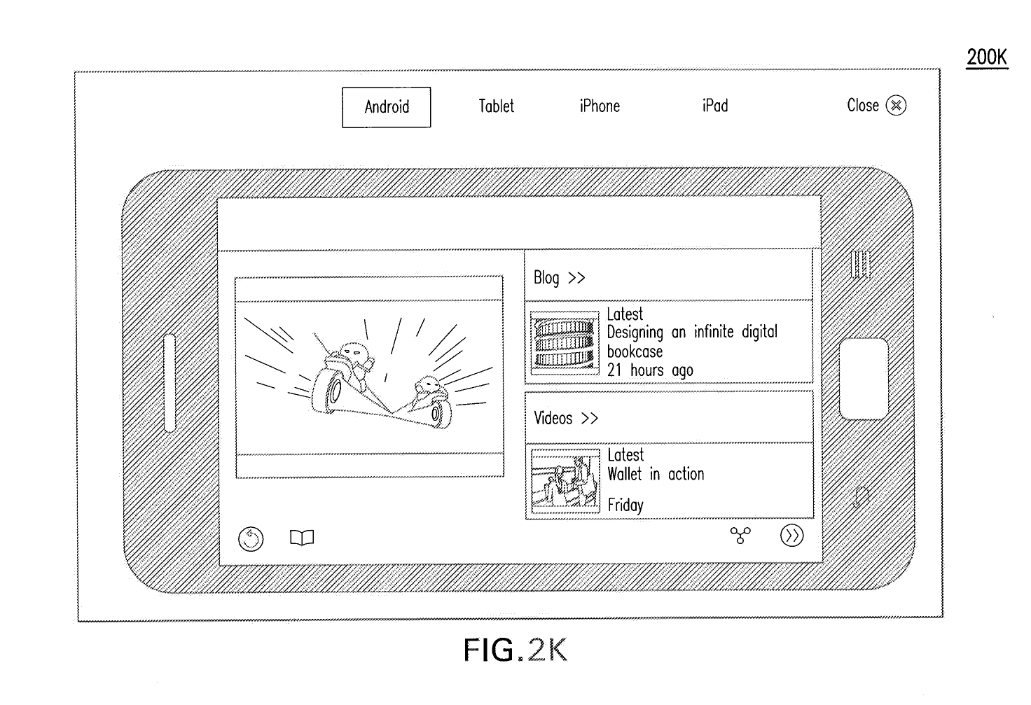

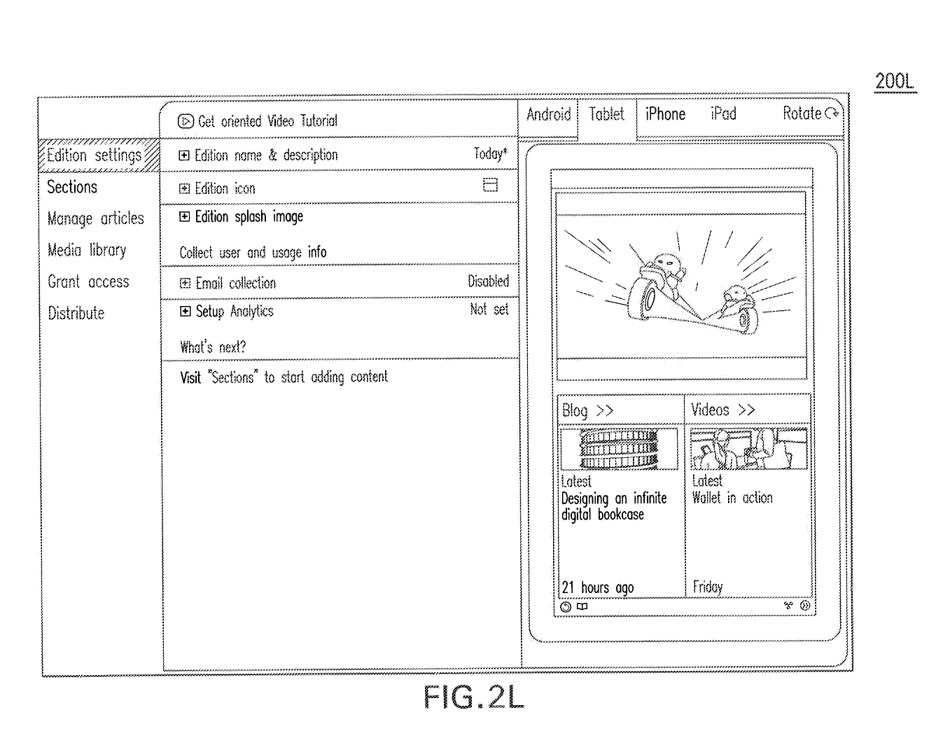

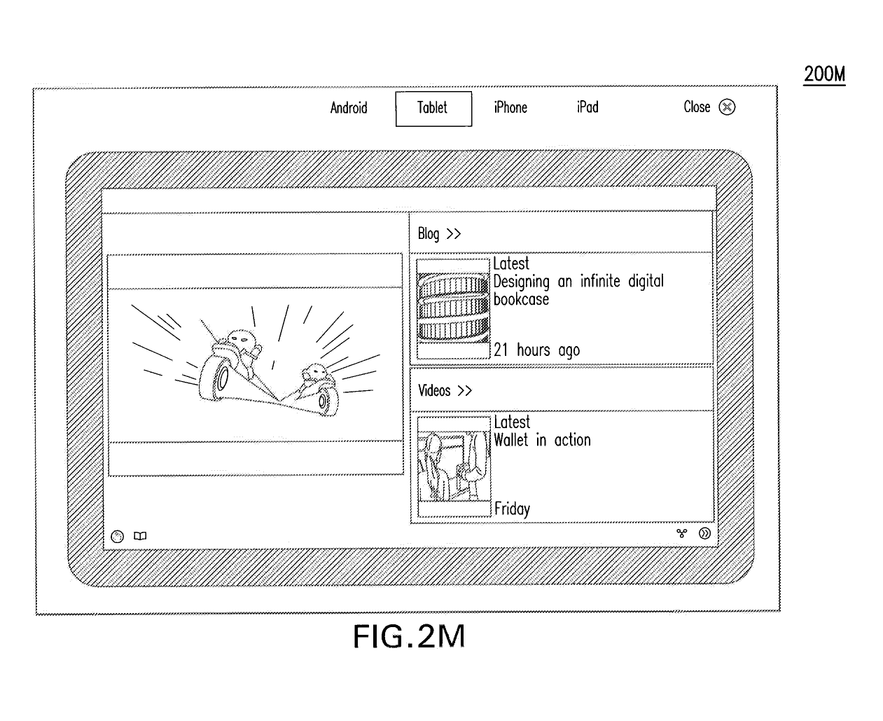

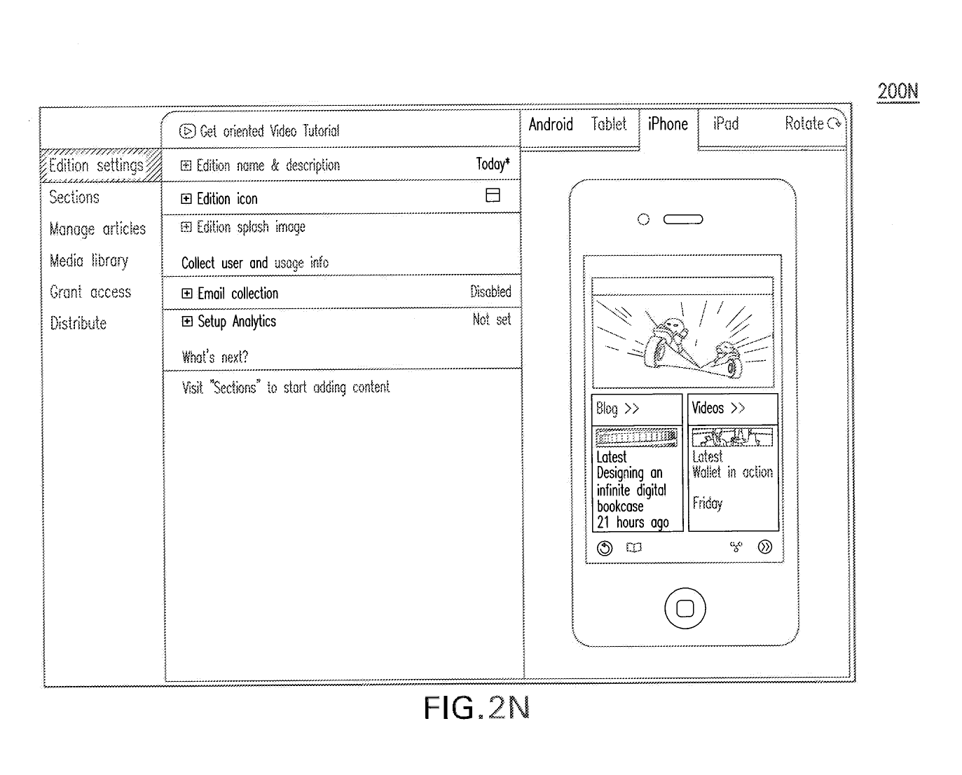

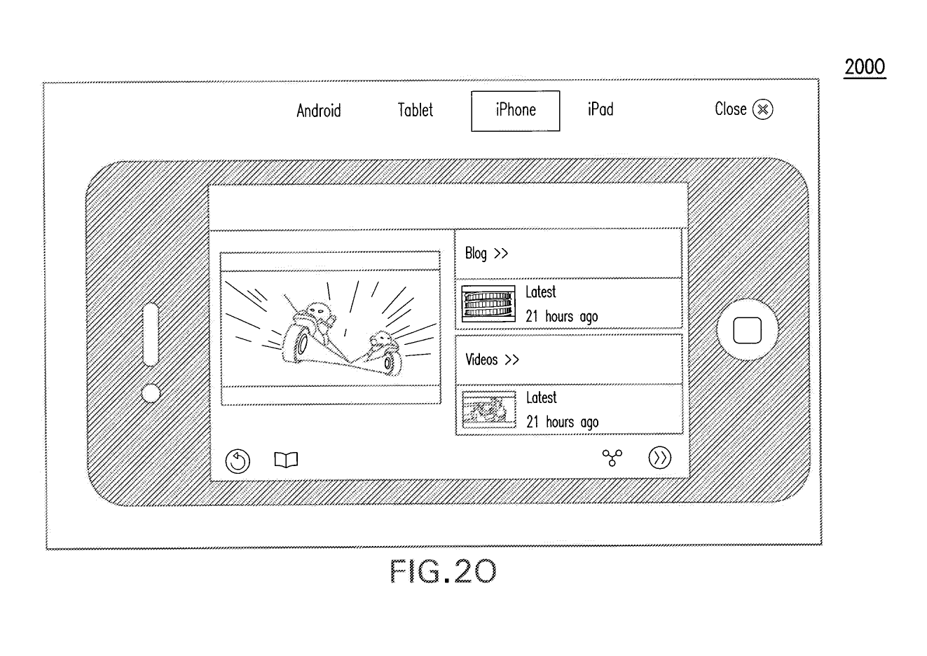

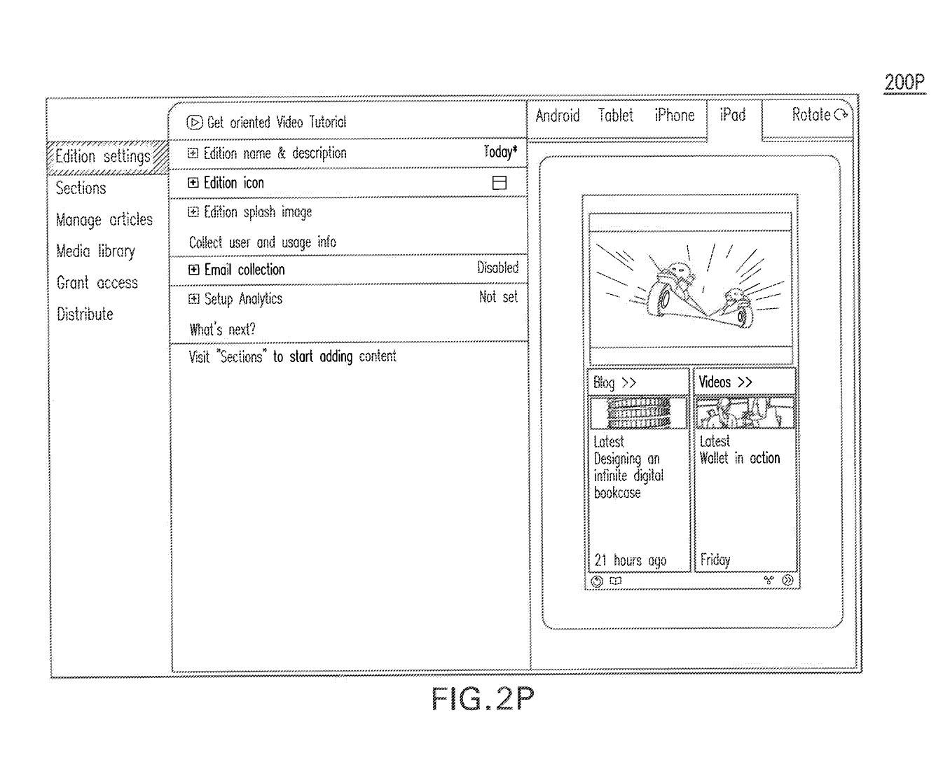

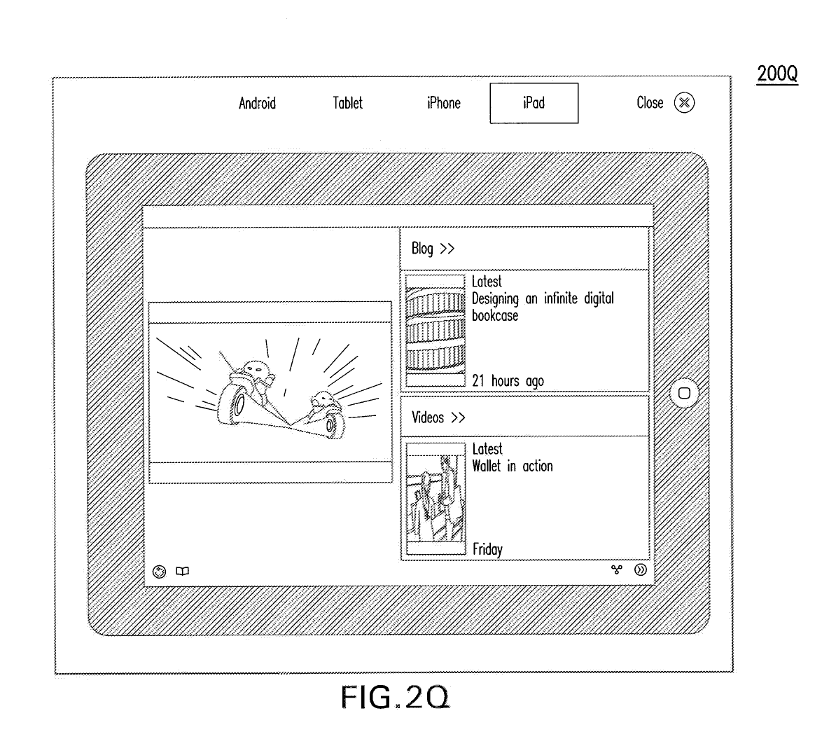

FIG. 2A is a block diagram 200A of an environment for designing a magazine edition, according to an embodiment. Block diagram 200A includes studio UI 110 and producer server 108 that communicate using network 102. Web server 104 hosts studio UI 110 that publisher 120 accesses using a unified resource locator (URL) or a web address. Studio UI 110 allows publisher 120 to design magazine editions 112. Studio UI 110 also allows publishers to configure content sources 118 that provide edition content 132 to magazine editions 112, and once designed, distribute magazine editions 112 to mobile devices 106.

Studio UI 110 includes a user interface 202. User interface 202 allows publisher 120 to configure the layout of edition content 132 that is included in magazine edition 112 into sections, articles, libraries, etc., and preview the configured edition content 132. User interface 202 includes an edition content configuration section 204 and an edition content display section 206. FIG. 2B is a screenshot 200B of an exemplary studio UI 110 that includes edition content configuration section 204 and edition content display section 206.

Edition content configuration 204 allows publisher 120 to design magazine edition 112. FIG. 2C is a screenshot 200C of an exemplary edition magazine 112 designed by publisher 120. For example, publisher 120 may include a name and description for magazine edition 112 as shown in the exemplary screenshot 200C. Publisher 120 may also configure a category for magazine edition 112, such as, for example, lifestyle, business, science and technology, sports, entertainment, or design, as also shown in the exemplary screenshot 200C. In an embodiment, publisher 120 may also include a category specific to magazine edition 112. When magazine edition 112 is uploaded to mobile device 106, current module 115 may use the configured category to categorized or recommend magazine edition 112 to the user.

Edition content configuration section 204 also allows publisher 120 to configure magazine edition 112 to interact with an analytics module. Analytics module is a module that executes within edition player 116 on mobile device 106. An analytics module tracks sections and posts within each magazine edition 112 that were read by a user. Analytics module may compile a listing of the read content and transmit the listing to publisher's 120 analytics account. Publisher 120 may then use the listing to determine a type of edition content 132 that is interesting to the user, or configure third-party services 122 that are popular with the users in subsequent versions of magazine edition 112.

Edition content configuration section 204 allows publisher 120 to configure multiple sections within magazine edition 112. FIG. 2D is a screenshot 200D of a publisher configuring a section for a magazine edition. When publisher 120 configures a section, studio UI 110 allows publisher 120 to configure a section type, such as a section that may receive an RSS feed section, documents, such as HTML documents or electronic publications, photographs, video clips, or blog content. When publisher 120 selects a section type, studio UI 110 presents publisher 120 with an interface and layout templates (described below) for displaying content that is configured for a particular section type.

Edition content configuration section 204 also allows publisher 120 to configure content source 118 that provides edition content 132 for display using magazine edition 112, as shown in screenshot 200D.

Once publisher 120 configures multiple sections using studio UI, publisher 120 uses edition content configuration section 202 to design a table of contents. FIG. 2E is a screenshot of an exemplary embodiment for designing a table of contents (“TOC”) using studio UI. Studio UI 110 provides publisher 120 with layout templates for presenting the TOC on mobile devices 106 having different specifications, such as a tablet and a smartphone, as shown in screenshot 200E.

Templates control the rendering of edition content in the TOC and in each section. Templates are stored in template module 216 on studio backend 126. Templates may be native templates 212. Native templates are optimized for displaying edition content 132 in magazine edition 112. For example, native templates 212 include libraries that are customized to interact with the modules and libraries included in studio backend 126. Native templates 212 may also be specific to processing a particular type of edition content 132, such as news, video or social media content. In an embodiment, when publisher 120 uses native templates 212 in magazine edition 112, publisher 120 uses studio UI 110 to configure native template 212 to a particular portion in magazine edition 112, such as a TOC in screenshot 200E.

Native templates 212 are stored in template storage 216. When publisher 120 configures native template 212 within magazine edition 112, studio UI 110 includes an association between native template 212 stored in template storage 216 and magazine edition 112. When producer server 108 distributes magazine edition 112 to mobile devices 106, native templates 212 are also distributed to mobile devices 106 to lay out edition content 132 on mobile devices 106.

Templates may also be custom templates 214. Custom templates 214 are designed by publisher 120 to display edition content in a particular section of magazine edition 112. Studio 110 allows publisher 120 to use custom templates 214 to control the layout of TOC or edition content 132 on mobile devices 106 that have display screens of various sizes. For example, publisher 120 may use studio UI 110 to design custom template 214 to display a TOC on a smartphone.

When publisher 120 uses designs custom template 214, studio UI 110 presents publisher 120 with a text box for entering custom template 214. Custom template 214 is then uploaded to studio backend 126 from studio UI 110. Custom template 214 is also stored in template storage 216 on studio backend 126 and is associated with magazine edition 112. As with native Templates 212, when producer server 108 distributes magazine edition 112 to mobile devices 106, custom templates 214 are also distributed to mobile devices 106 to lay out edition content 132 on mobile devices 106.

Once publisher 120 configures multiple sections using studio UI 110, publisher 120 uses edition content configuration section 204 to configure the display of each section in magazine edition 112. FIG. 2F is a screenshot 200F of an exemplary embodiment for designing a layout for a section. Studio UI 110 allows a publisher 120 to configure the name of each section. Studio UI 110 also allows publisher 120 to select one or more content sources 118 that provides edition content 132 to each section. A user may be enabled to make any type of selection including but not limited to enabling a user to select a content source through a user-interface, enter a content course identifier at a user-interface, or any other way of allowing a user to identify or configure a content source to allow access to the content provided by the content source. For example, a publisher 120 through studio UI 110 can select content source 118, such as an RSS feed 118A, social stream 118B, multimedia 118C, etc., for providing edition content 118 to producer server 108. Publisher 120 can enter a web address associated with content source 118, such as an RSS feed 118A or select content source 118 from a listing of preselected content sources 118 in studio UI 110. The content sources 118 that are in the listing may have web addresses preconfigured and stored on producer server 108. Once content sources 118 are selected and uploaded to producer server 108, data connector 130 may use the provided web addresses to access associated content sources 118 and retrieve edition content 132 for display using magazine edition 112.

This feature allows magazine edition 112 to display edition content 132 from multiple content sources 132 within a single magazine edition 112.

As with TOC, studio UI 110 provides publisher 120 with native templates 212 and custom templates 214 for designing a layout of each section. This allows studio UI 110 to present publisher 120 with a flexible approach for designing a layout of magazine edition 112 for mobile devices 106 of different sizes, such as tablets and smartphones. For example, studio UI 110 provides publisher 120 with a selection of native templates 212 that are configured to layout different types of edition content 132. In another example, studio UI 110 provides publisher 120 with a text box for inserting CSS and HTML code to design a custom template 214.

Studio UI 110 also allows publisher 120 to use native templates 212 or custom templates 214 to design a header for each section as shown in screenshot 200F. Studio UI 110 also allows publisher 120 to use native templates 212 or design custom templates 214 to lay out articles (also referred to as “posts”) within each section, as also shown in screenshot 200F.

In an embodiment, studio UI 110 allows publisher 120 to design customized sections that for example, include projects that require user collaboration. FIG. 2G is a screenshot 200G of an exemplary embodiment of a customized section. In addition to a section name and a content source configurations, customized sections also include user contribution fields, such as a title, image, location, note or a field that may be configured by publisher 120, as shown in screenshot 200G. Those fields are provided to users using mobile devices 106 and allow users to add, for example, text or image content, or indicate a present location of mobile device 106. Once a user enters content within the field, the content is synchronized with other magazine editions 112 that execute on mobile devices 106. As with other sections, customized section may also include native and custom templates 214 to present edition content 132 using native templates 212 and custom templates 214.

Edition content configuration section 204 also allows publisher 120 to configure the user population that views and modifies edition content 132 provided by magazine edition 112. FIG. 2H is a screenshot 20011 for configuring a user population using studio UI 110, according to an embodiment. For example, each section within magazine edition 112 may be configured for viewing by any user, a select group of users, publishers 120 only, etc. The users may be selected based on the user profile that specifies the group to which each user belongs.

Edition content configuration section 204 allows publisher 120 to distribute magazine edition 112 to mobile devices 106 or to edition distributors 124. FIG. 2I is a screenshot 2001 of an exemplary embodiment for distributing a magazine edition. In one embodiment, studio UI 110 allows for distribution of a designed magazine edition 112 to an account associated with publisher 120. This type of distribution allows publisher 120 to test the designed magazine edition 112, prior to distributing magazine edition 112 to multiple users.

In another embodiment, edition content configuration section 204 also allows publisher 120 to configure third-party services 122 that provide services to users using magazine editions 112. For example, studio UI 110 allows publisher 120 to select advertisers that may provide advertisements to magazine edition 112. For example, when magazine edition 112 displays edition content 132 on mobile device 106, magazine edition 112 may query an advertiser and retrieve advertisements that may be integrated with edition content 132 and be displayed to a user.

In another embodiment, edition content configuration section 204 allows publisher 120 to select merchandize items that may be included for sale in magazine edition 112. Edition content configuration section 204 also allows publisher 120 to configure a check out interface so that users are able to purchase the merchandize items that are offered for sale.

Edition content display section 206 allows publisher 120 to preview the configured edition content 132 from content sources 118 that publisher 120 configured for each magazine edition 112.

In an embodiment, edition content display section 206 displays edition content 132 as it may be displayed on various mobile devices 106, such as a tablet or smart phones of different sizes, to name a few. For example, after configuring a main page of magazine edition 112, publisher 120 may select to simulate a preview of edition content 132 using a particular mobile device 106. Additionally, edition content display section 206 may also simulate a preview in various orientations for mobile devices 106 that may flip the displayed content to accommodate the vertical or horizontal orientations. FIG. 2J is screenshot 200J of an exemplary embodiment of an edition content display section simulating the display of magazine edition 112 on a smartphone. FIG. 2K is screenshot 200K of an exemplary embodiment of an edition content display section simulating the display of magazine edition 112 in a horizontal orientation. As described herein, because the layout of edition content 132 depends on the specifications (such as dimensions of the display screen) of mobile device 106, each time the orientation of mobile device 106 changes, magazine edition layout, TOC layout and section layout are redesigned and redisplayed on mobile device 106.

FIG. 2L is screenshot 200L of an exemplary embodiment of an edition content display section simulating the vertical display of magazine edition 112 on a tablet device. FIG. 2M is screenshot 200M of an exemplary embodiment of an edition content display section simulating the display of magazine edition 112 in a horizontal orientation on the tablet device.

In an embodiment, studio UI 110 may also allow a preview display for mobile devices 106 that vary in size. For example, smartphone devices may vary in size, as do tablet devices. FIG. 2N and FIG. 2O are exemplary embodiments of a layout preview on a smartphone having different dimensions than the smartphone in FIG. 2J and FIG. 2K. In another example, FIG. 2P and FIG. 2Q are exemplary embodiments of a layout preview on a tablet device having different dimensions than the tablet in FIG. 2L and FIG. 2M.

Going back to FIG. 2A, studio UI 110 also includes a layout engine 208. Layout engine 208 is a module that integrates native templates 212 and custom templates 214 with edition content 132. Layout engine 208 accesses the dimensions stored on producer server 108 of the simulated mobile devices described in FIGS. 2J-2Q. Layout engine 208 then uses the configuration provided by publisher 120 and the accessed dimensions to generate the TOC, sections and posts with edition content 132 provided by the configured content sources 118.

In an embodiment, layout engine, such as layout engine 208′ may also be located in studio backend 126. When studio backend 126 includes layout engine 208, the integration of magazine edition 112 for preview purposes occurs on producer server 108. Producer server 108 then transmits the integrated magazine edition for display in studio UI.

Studio UI 110 also includes a communication interface 210. Communication interface 210 receives edition content 132 from data storage 128 for content source 118 that publisher 120 selects for display using magazine edition 112. Once received, layout engine 208 integrates the edition content 132 with magazine edition 112 designed by publisher 120 and allows publisher 120 to preview the designed layout for the main page, TOC, sections and posts in magazine edition 112. Communication interface 210 also transmits the settings for magazine edition 112, its TOC, sections, posts, etc. and custom templates designed by publisher 120 for TOC, sections, posts, etc., for storage on producer server 108.

When publisher 120 completes designing magazine edition 112 using studio UI 110, communication interface 210 also transmits magazine edition 112 for distribution to mobile devices 106. For example, communication interface 210 transmits magazine edition 112 to producer server 108 for distribution.

Producer server 108 also includes magazine edition storage 218. When publisher 120 completes designing magazine edition 112 using studio UI 110, the designed magazine edition 112 may be stored in magazine edition storage 218. Mobile devices 106 may request magazine edition 112 from magazine edition storage 218 for upload to mobile devices 106 or to synchronize a new version of magazine edition 112 with the versions that exist on mobile devices 106.

To distribute magazine editions 112 to mobile devices 106, producer server 108 includes edition distribution module 220. Edition distribution module 220 distributes magazine editions 112 to mobile devices 106 or edition distributors 124. Edition distribution module 220 also synchronizes the new versions of magazine applications 112 that are provided by publisher 120 with the previous versions of magazine applications 112 that were previously uploaded to mobile devices 106.

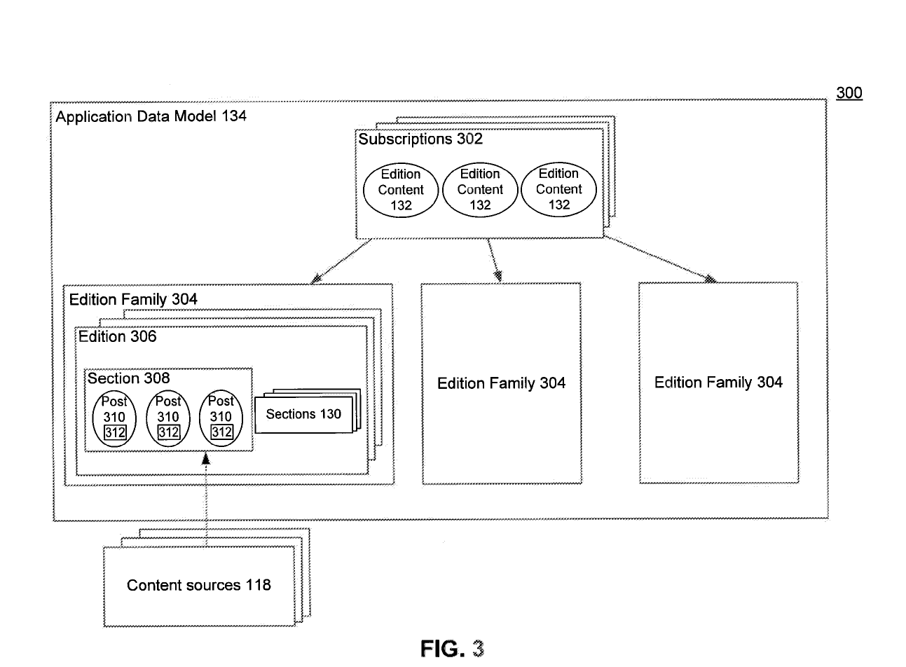

FIG. 3 is a block diagram 300 of an application data model, according to an embodiment. Application data model 134 is a data model that magazine edition 112 uses to display edition content 132. When publisher 120 builds magazine edition 112 using studio UI 110, it configures edition content 132 into categories that correspond to the configuration in application data model 134.

Application data model 134 includes multiple subscriptions 302. Each subscription 302 is a subscription to content source 118 from which a user subscribes to receive edition content 132 within magazine edition 112. When a user is a publisher, a user may wish to subscribe to his own or another publisher's 120 content source 118. A user who is not a publisher may wish to subscribe to a third party's (e.g. publisher's 120) content source 118.

Magazine edition 112 may be included in an edition family 304. Edition family 304 may include multiple magazine editions 112 that are related according to the publisher's 120 criteria. Edition family 304 may also include a single magazine edition 112.

Edition content 132 in each edition family 304 may be distributed among multiple editions 306. In the application data model 124, editions 306 are placeholders for magazine editions 112. Example editions 306 in edition family 304 may include news content, blog content, video content, etc. Publisher 120 may decide which edition content 132 from source 118 to include in a particular edition 306. Additionally, when publisher 120 designs each edition 306 using studio UI 110, multiple designers associated with a particular publisher 120 may design a particular edition 306 or a set of editions 306 at the same time.

Editions 306 may include multiple sections 308. Each section corresponds to a section in studio UI 110 that is configured to publisher 120. Sections 308 organize edition content 132 that is provided from content sources 118. For example, edition 306 that includes news content may include a news section and a style section. In another example, edition 306 that includes travel content may include multiple travel sections where each section 308 corresponds to a different region in the world. Each section 308 also includes a TOC, header, templates (such as native templates 212 and custom templates 214) for laying out edition content 132, content source identifiers, etc.

Each section 308 may also include a section type. Section type allows studio UI 110 to optimize the presentation of edition content 132 that is included in section 308 of a particular type. For example, section types may include an RSS feed type, video channel type, social stream type, photo type, products-for-sale type, user-generated articles type that includes citizen journalism, etc. Each native template 212 may be provided by studio backend 126 to studio UI 110 to lay out edition content 132 of a particular type.

Each section 308 includes posts 310. Post 310 represents data associated with a particular unit of content, such as an article, a video, a single image, a “tweet”, a slide show, a map, or any unit of content within content source 118. Each post 310 may also be configured using templates 212 or templates 214 as shown in screenshot 200F. In an embodiment, post 310 includes multiple items 312. Each item 312 includes information associated with post 310. Example items 312 may include information such as a title, a body, an author, a byline, a media, etc.

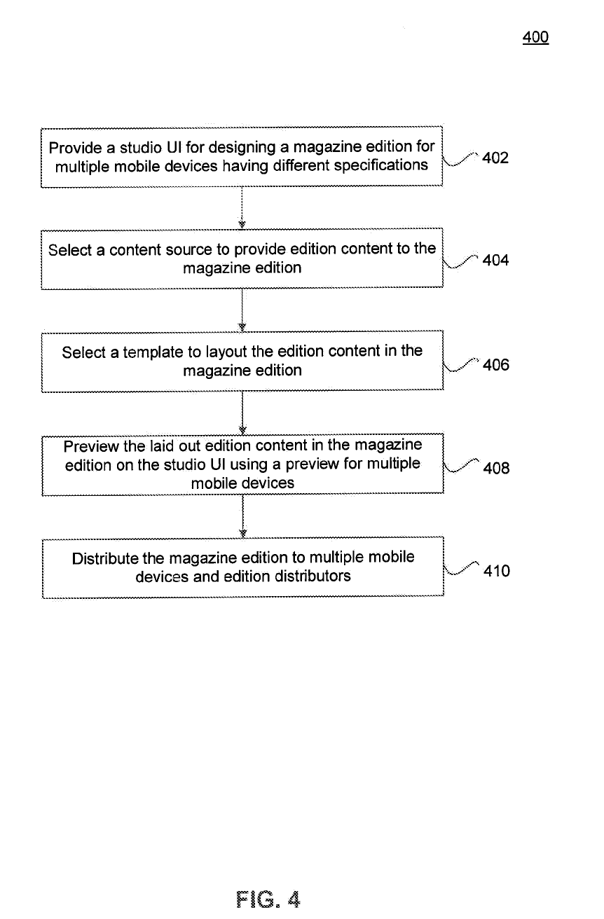

FIG. 4 is a flowchart 400 of a method for designing a magazine edition, according to an embodiment.

At stage 402, a user interface is provided. For example, studio UI 110 provides an interface for designing magazine editions 112 for multiple mobile devices having different specifications from studio backend. As described herein, the different options for designing magazine editions 112 are shown in screenshots 200B-200Q.

At stage 404, a content source is selected. For example, studio UI 110 enables a publisher 120 to select one or more content sources 118 that provide edition content 132 to each section in magazine edition 112. For example, a publisher 120 can select content source 118, such as an RSS feed 118A, social stream 118B, etc., to provide edition content to producer server 108. For example, publisher 120 can enter a web address associated with content source 118, such as an RSS feed 118A or select content source from a listing of preselected content sources 118 in studio UI 110. As described herein, edition content 132 may include news articles, videos, etc.

At stage 406, a template is selected. For example, studio UI 110 allows publisher 120 to select native templates 212 to display edition content 132 according to a layout provided by studio backend 126. In another example, studio UI 110 receives custom template 214 from publisher 120 that allows publisher 120 to design his own layout to display edition content 132. Once received, studio UI allows publisher 120 to select custom template 214.

At stage 408, the layout of edition content is previewed. For example, studio UI 110 receives edition content 132 from content source 118 configured in stage 404. Studio UI 110 also receives native templates 212 and custom templates 214 that were selected or designed in stage 406. Once edition content 132 and native templates 212 and custom templates 214 are received, layout engine 208 integrates edition content 132 with native templates 212 and custom templates 214. This provides publisher 120 with a preview of magazine edition 112, and, for example, sections and TOC within magazine edition 112 on studio UI 110. Studio UI 110 also allows a simulated preview using multiple mobile devices 106 that have different specifications and layout orientations.

At stage 410, a magazine edition is distributed. For example, studio UI 110 distributes the designed magazine edition 112 to mobile devices 106. Studio UI 110 may transmit magazine edition 112 to magazine edition storage 218. From magazine edition storage 218, studio backend 126 distributes magazine editions 112 and corresponding native templates 212 and custom templates 214 to mobile devices 106 and edition distributors 124. Studio UI 110 may also make magazine edition 112 available for transmission or synchronization on producer server 108.

FIG. 5 is an example computer system 500 in which embodiments of the present invention, or portions thereof, may be implemented as computer-readable code. For example, the components or modules of distributed system 100, such as studio UI 110, magazine editions 112, current module 115, studio backend 126, edition runner 116, etc., may be implemented in one or more computer systems 500 using hardware, software, firmware, tangible computer-readable media having instructions stored thereon, or a combination thereof and may be implemented in one or more computer systems or other processing systems. Modules and components in FIGS. 1-4 may be embodied in hardware, software, or any combination thereof.

Mobile Device 106, web server 104 and producer server 108 may include one or more computing devices that include a computer system 500. Computer system 500 may include one or more processors 502, one or more non-volatile storage mediums 504, one or more memory devices 506, a communication infrastructure 508, a display screen 510 and a communication interface 512.

Processors 502 may include any conventional or special purpose processor, including, but not limited to, digital signal processor (DSP), field programmable gate array (FPGA), and application specific integrated circuit (ASIC).

GPU 514 is a specialized processor that executes instructions and programs, selected for complex graphics and mathematical operations, in parallel.

Non-volatile storage 504 may include one or more of a hard disk drive, flash memory, and like devices that may store computer program instructions and data on computer-readable media. One or more of non-volatile storage device 504 may be a removable storage device.

Memory devices 506 may include one or more volatile memory devices such as but not limited to, random access memory. Communication infrastructure 508 may include one or more device interconnection buses such as Ethernet, Peripheral Component Interconnect (PCI), and the like.

Typically, computer instructions are executed using one or more processors 502 and can be stored in non-volatile storage medium 504 or memory devices 506.

Display screen 510 allows results of the computer operations to be displayed to a user or an application developer.

Communication interface 512 allows software and data to be transferred between computer system 500 and external devices. Communication interface 512 may include a modem, a network interface (such as an Ethernet card), a communications port, a PCMCIA slot and card, or the like. Software and data transferred via communication interface 512 may be in the form of signals, which may be electronic, electromagnetic, optical, or other signals capable of being received by communication interface 512. These signals may be provided to communication interface 512 via a communications path. The communications path carries signals and may be implemented using wire or cable, fiber optics, a phone line, a cellular phone link, an RF link or other communications channels.

Embodiments also may be directed to computer program products comprising software stored on any computer-useable medium. Such software, when executed in one or more data processing device(s), causes a data processing device(s) to operate as described herein. Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1. A computer-implemented method for designing different magazine editions configured to provide respective edition content for display on different respective mobile devices, comprising:
providing a user-interface for designing a magazine edition;
enabling a user to select through the user-interface at least one content source to provide the respective edition content to the magazine edition;
enabling the user to select one or more layout templates for the magazine edition through the user interface, each layout template being associated with a specific type of a mobile device configured to display the magazine edition;
configuring the selected one or more layout templates to define display of the respective edition content in the magazine edition;
providing during the configuring a preview of the respective edition content in the magazine edition according to the selected one or more layout templates such that the preview simulates the layout of the magazine edition on a plurality of mobile devices having specifications specific to the respective mobile devices; and
sending the configured one or more layout templates for the magazine edition to the plurality of mobile devices, whereby the magazine edition is displayed at the plurality of mobile devices according to the configured one or more layout templates and including the selected edition content for the magazine edition.

2. (canceled)

3. The computer-implemented method of claim 1, wherein the preview simulates each type of the mobile device.

4. The computer-implemented method of claim 1, wherein the preview simulates both a vertical layout and a horizontal layout of the magazine edition on each type of the mobile device.

5. The computer-implemented method of claim 1, further comprising:
receiving a layout template as a native template, wherein the native template is optimized for displaying the edition content in the magazine edition.

6. The computer-implemented method of claim 1, further comprising:
receiving a layout template as a custom template, wherein the custom template customizes the display of the edition content in the magazine edition.

7. The computer-implemented method of claim 1, further comprising:
enabling the user to select a second content source to provide the edition content to a section within the magazine edition.

8. The computer-implemented method of claim 7, wherein the second content source is at a mobile device, and further comprising:
configuring a section of the magazine edition to receive edition content from the second content source at the mobile device for distribution to a plurality of other mobile devices.

9. The computer-implemented method of claim 1, further comprising:
based on a selection for granting access to a plurality of users using the user interface to the magazine edition, configuring a plurality of user profiles for accessing the magazine edition.

10. The computer-implemented method of claim 1, further comprising:
based on a selection of a third-party service using the user interface, configuring the third-party service to provide services to the magazine edition when the magazine edition is displayed on a mobile device.

11. The computer-implemented method of claim 10, wherein a type of the third-party service may be based on the specification associated with each mobile device or an action received from the user using the magazine edition.

12. The computer-implemented method of claim 1, further comprising:
distributing the magazine edition to a current module, wherein the current module displays a plurality of magazine editions on a mobile device.

13. The computer-implemented method of claim 1, further comprising:
distributing the magazine edition to an edition distributor, wherein the edition distributor distributes the magazine edition to the plurality of mobile devices respectively.

14. The computer-implemented method of claim 1, wherein the display of the magazine edition on a mobile device is a function, at least in part, of dimensions of a display screen and an operating platform of the mobile device.

15. A system for designing different magazine editions configured to provide respective edition content for display on different respective mobile devices, comprising:
a studio backend configured to:
provide a user-interface for designing a magazine edition;
enable a user to select through the user-interface at least one content source to provide the respective edition content to the magazine edition;
enable the user to select one or more layout templates for the magazine edition through the user interface, each layout template being associated with a specific type of a mobile device configured to display the magazine edition;
configure a the selected layout templates to define the display of the respective edition content in the magazine edition;
provide during the configuring a preview of the respective edition content in the magazine edition according to the selected one or more layout templates such that the preview simulates the layout of the magazine edition on a plurality of mobile devices having specifications specific to the respective mobile devices; and
send the configured one or more layout templates for the magazine edition to the plurality of mobile devices, whereby the magazine editions is displayed at the plurality of mobile devices according to the configured one or more layout templates and including the selected edition content for the magazine edition.

16. (canceled)

17. The system of claim 15, wherein the preview simulates each type of the mobile device.

18. The system of claim 15, wherein the preview simulates both a vertical layout and a horizontal layout of the magazine edition on each type of the mobile device.

19. The system of claim 15, wherein the studio backend is further configured to:
receive the layout template as a native template, wherein the native template is optimized for display of the edition content in the magazine edition.

20. The system of claim 15, wherein the studio backend is further configured to:
receive the layout template as a custom template, wherein the custom template customizes the display of the edition content in the magazine edition.

21. The system of claim 15, wherein the studio backend is further configured to:
enable the user to select a second content source to provide the edition content to a section within the magazine edition.

22. The system of claim 21, wherein the second content source at a mobile device, and the studio backend is further configured to:
configure a section of the magazine edition to receive edition content from the second content source at the mobile device for distribution to a plurality of other mobile devices.

23. The system of claim 15, wherein the studio backend is further configured to:
based on a selection for granting access to a plurality of users using the user interface to the magazine edition, configure a plurality of user profiles, wherein the user associated with a respective user profile is granted access to the magazine edition.

24. The system of claim 15, wherein the studio backend is further configured to:
based on a selection of a third-party service using the user interface, configure the third-party service to provide services to the magazine edition when the magazine edition is displayed on a mobile device.

25. The system of claim 15, wherein a type of a third-party service may be based on a type of a mobile device or an action received from a user using the magazine edition.

26. The system of claim 15, wherein the studio backed is further configured to:
distribute the magazine edition to a current module, wherein the current module displays a plurality of magazine editions on a mobile device.

27. The system of claim 15, wherein the studio backend further configured to:
distribute the magazine edition to an edition distributor, wherein the edition distributor distributes the magazine edition to the plurality of mobile devices respectively.

28. The system of claim 15, wherein the display of the magazine edition on a mobile device is a function, at least in part, of dimensions of a display screen and an operating platform of the mobile device.
